(19) United States
(12) Patent Application Publication
(10) Pub. No.: US 2024/0326924 A1
(43) Pub. Date: Oct. 3, 2024

(54) VEHICLE BOTTOM STRUCTURE

(71) Applicant: Honda Motor Co., Ltd., Tokyo (JP)

(72) Inventors: Yoshitaka IZUMI, Tokyo (JP); Rei TOGASHI, Tochigi (JP)

(73) Assignee: Honda Motor Co., Ltd., Tokyo (JP)

(21) Appl. No.: 18/408,583

(22) Filed: Jan. 10, 2024

(30) Foreign Application Priority Data
Mar. 29, 2023 (CN) 202310319419.2

(51) Int. Cl. B62D 25/20; B62D 21/15

(52) U.S. Cl. CPC B62D 25/20; B62D 21/15

(57) ABSTRACT

A vehicle bottom structure includes: a floor bottom panel, including a floor tunnel portion and a bottom panel portion; side beams, disposed on an outer side of the floor bottom panel in a vehicle width direction, and extending along a vehicle front-back direction; first and second cross members, respectively disposed on a central side and a back end side of the floor tunnel portion in the vehicle front-back direction, and extending along the vehicle width direction; and a patch component, disposed between the first and second cross members. The floor tunnel portion is disposed on a central side between the side beams in the vehicle width direction, and extends along the vehicle front-back direction. The bottom panel portion is disposed between the side beams and the floor tunnel portion. Part of the patch component overlaps a central side of the bottom panel portion in the vehicle width direction.

### CROSS-REFERENCE TO RELATED APPLICATION

This application claims the priority benefit of China application serial no. 202310319419.2, filed on Mar. 29, 2023. The entirety of the above-mentioned patent application is hereby incorporated by reference herein and made a part of this specification.

### BACKGROUND

### Technical Field

The disclosure relates to a vehicle bottom structure.

### Description of Related Art

In order to allow vulnerable groups such as the elderly, the disabled, children and the like to use a sustainable transportation system, commitments have been made to provide transportation vehicles with better vehicle body rigidity. In the existing technology, the vehicle bottom structure is disposed with structures such as cross members and the like to enhance bottom rigidity. However, there is no reinforcement structure between the front seats and the rear seats. If a child's chair is disposed at this time or a falling object hits the area, the floor bottom panel may be easily deformed. In order to solve the above-mentioned problems, the disclosure aims to avoid deformation of the floor bottom panel. Furthermore, the rigidity of the vehicle body is further improved and contributes to the development of a sustainable conveyor system.

### SUMMARY

The disclosure provides a vehicle bottom structure that can enhance rigidity of the floor bottom panel between front seats and rear seats.

A vehicle bottom structure of the disclosure includes: a floor bottom panel, including a floor tunnel portion and a bottom panel portion; side beams, disposed on an outer side of the floor bottom panel in a vehicle width direction, and extending along a vehicle front-back direction; a first cross member and a second cross member, respectively disposed on a central side and a back end side of the floor tunnel portion in the vehicle front-back direction, and extending along the vehicle width direction; and a patch component, disposed between the first cross member and the second cross member. The floor tunnel portion is disposed on a central side between the side beams in the vehicle width direction, and extends along the vehicle front-back direction. The bottom panel portion is disposed between the side beams and the floor tunnel portion. Part of the patch component overlaps a central side of the bottom panel portion in the vehicle width direction.

Based on the above, in the vehicle bottom structure of the disclosure, the patch component is disposed on the bottom panel portion of the floor bottom panel, and the patch component is disposed between the first cross member and the second cross member, that is, roughly corresponding to the position between the front seats and the rear seats in the vehicle body. In this way, the load transmitted by falling objects or the support legs of the child chair can be borne by the patch component, and the force can be further distributed to various places in the floor bottom panel to suppress the deformation of the bottom panel portion. In addition, the patch component can also increase the rigidity of areas where cross members are not disposed to suppress deformation caused by side impacts. Accordingly, the vehicle bottom structure of the disclosure can strengthen the rigidity of the floor bottom panel between the front seats and the rear seats.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a schematic three-dimensional view of a vehicle bottom structure according to an embodiment of the disclosure.

FIG. 2 is a partial top view of the vehicle bottom structure of FIG. 1.

### DESCRIPTION OF THE EMBODIMENTS

In an embodiment of the disclosure, the bottom panel portion further includes a plurality of longitudinal convex strips. The plurality of longitudinal convex strips extend along the vehicle front-back direction and disposed in parallel in the vehicle width direction. The patch component includes a first joining portion. The first joining portion is joined to the plurality of longitudinal convex strips.

In an embodiment of the disclosure, the bottom panel portion further includes a spacing portion. The spacing portion separates the plurality of longitudinal convex strips into the front and the back in the vehicle front-back direction. The patch component further includes a second joining portion. In a viewing angle in a vehicle up-down direction, the second joining portion is formed to overlap the spacing portion, and the second joining portion is joined to the spacing portion. In a viewing angle in the vehicle front-back direction, the first joining portions and the second joining portions are formed into a staggered arrangement in the vehicle width direction.

In an embodiment of the disclosure, the patch component further includes transverse convex strips extending along the vehicle width direction. The transverse convex strips are disposed further forward than the second joining portion in the vehicle front-back direction.

In an embodiment of the disclosure, in the viewing angle in the vehicle up-down direction, the transverse convex strips are formed to overlap the plurality of longitudinal convex strips.

In an embodiment of the disclosure, the patch component is formed such that a length in the vehicle width direction is greater than a length in the vehicle front-back direction, and a distance in which the patch component extends from the central side of the bottom panel portion in the vehicle width direction toward the outer side is greater than a distance in which the patch component extends from the central side of the bottom panel portion in the vehicle width direction toward the inner side.

In an embodiment of the disclosure, the patch component is formed such that a length in the vehicle width direction is greater than a length in the vehicle front-back direction, and the patch component is formed away from the floor tunnel portion and the side beam in the vehicle width direction. A gap between the patch component and the side beam is smaller than a gap between the patch component and the floor tunnel portion.

In an embodiment of the disclosure, the first cross member is a front cross member connecting the floor tunnel portion and the side beam, and the second cross member is a back cross member connecting the side beams at a back end portion of the floor tunnel portion in the vehicle front-back direction.

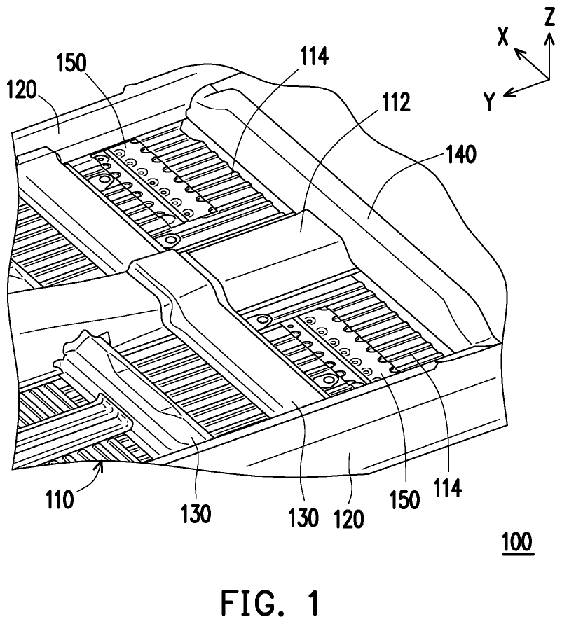

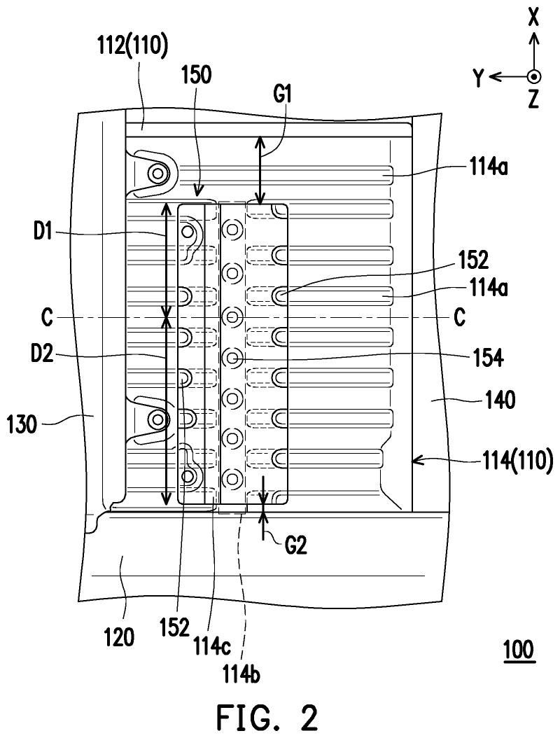

FIG. 1 is a schematic three-dimensional view of a vehicle bottom structure according to an embodiment of the disclosure. FIG. 2 is a partial top view of the vehicle bottom structure of FIG. 1. In the embodiment, a vehicle bottom structure 100 is, for example, a bottom structure used in an ordinary passenger car (not shown), especially the area structure between the front seats (not shown) and rear seats (not shown) in the vehicle body, but may also be applied to other devices with similar structures, and the disclosure is not limited thereto. A vehicle width direction X, a vehicle front-back direction Y, and a vehicle up-down direction Z in the drawings are not intended to limit the positional relationship of each component in the disclosure. In addition, it should be noted that, unless otherwise specified, the front and up used herein are the directions pointed by the vehicle front-back direction Y and the vehicle up-down direction Z arrows, and the back and down used herein are the opposite directions mentioned above; the inner side and outer side used herein are relative positions in the vehicle width direction X. The direction pointed by the vehicle width direction X arrow is not used to limit the inner side or the outer side. Whenever possible, the same reference numbers are used in the drawings and description to refer to the same or similar parts. The vehicle bottom structure 100 of the embodiment will be described below with reference to FIG. 1 and FIG. 2.

Please refer to FIG. 1. In the embodiment, the vehicle bottom structure 100 includes a floor bottom panel 110 and side beams 120. The floor bottom panel 110 includes a floor tunnel portion 112 and a bottom panel portion 114. The side beams 120 are disposed on the outer side of the floor bottom panel 110 in the vehicle width direction X and extend along the vehicle front-back direction Y. In other words, the floor bottom panel 110 is disposed between the side beams 120. The floor tunnel portion 112 is disposed on the central side between the side beams 120 in the vehicle width direction X, and extends along the vehicle front-back direction Y. Furthermore, the floor tunnel portion 112 is formed in a convex shape protruding upward in the vehicle up-down direction Z. The bottom panel portion 114 is disposed between the side beams 120 and the floor tunnel portion 112 (that is, the bottom panel portion 114 is disposed on each of the two opposite outer sides of the floor tunnel portion 112 in the vehicle width direction X). Under the viewing angle in the vehicle front-back direction Y, the cross-sections of the floor tunnel portion 112 and the bottom panel portion 114 are formed into a hat shape with the opening facing downward, but the disclosure is not limited thereto.

In addition, in the embodiment, the vehicle bottom structure 100 further includes a first cross member 130, a second cross member 140, and a patch component 150. The first cross member 130 and the second cross member 140 are respectively disposed on the central side and the back end side of the floor tunnel portion 112 in the vehicle front-back direction Y, and extend along the vehicle width direction X to the side beams 120 on the two opposite sides. The number of the first cross-beam member 130 is not limited to two, and the number of the second cross-beam member 140 is not limited to a single one, and can be adjusted according to actual requirements. The patch component 150 is disposed on the bottom panel portion 114 and is located between the first cross member 130 and the second cross member 140. Part of the patch component 150 overlaps the central side of the bottom panel portion 114 in the vehicle width direction X (the center line C shown in FIG. 2), that is, spanning the area near the central side (the center line C shown in FIG. 2) of the bottom panel portion 114 in the vehicle width direction X.

It can be seen from this that in the vehicle bottom structure 100 of the embodiment, the patch component 150 is disposed on the bottom panel portion 114 of the floor bottom panel 110, and the patch component 150 is disposed between the first cross member 130 and the second cross member 140, which roughly corresponds to the position between the front seats and the rear seats in the vehicle body. In this way, the load transmitted by falling objects or the support legs of the child chair can be borne by the patch component 150, and the force can be further distributed to various places in the floor bottom panel 110 to suppress the deformation of the bottom panel portion 114. In addition, the patch component 150 can also increase the rigidity of the area where the cross member is not disposed to suppress deformation caused by side impact. Accordingly, the vehicle bottom structure 100 of the embodiment can enhance the rigidity of the floor bottom panel 110 between the front seats and the rear seats.

Furthermore, in the embodiment, the first cross member 130 is a front cross member connecting the floor tunnel portion 112 and the side beam 120, and the second cross member 140 is a back cross member connecting the side members 120 at the back end portion of the floor tunnel portion 112 in the vehicle front-back direction Y, but the disclosure is not limited thereto, and it may also be a common cross member in other vehicle bodies.

Please refer to FIG. 2. In the embodiment, the bottom panel portion 114 further includes a plurality of longitudinal convex strips 114a, a spacing portion 114b, and a transverse convex strip 114c. The plurality of longitudinal convex strips 114a extend along the vehicle front-back direction Y and are disposed in parallel in the vehicle width direction X. The spacing portion 114b extends along the vehicle width direction X to separate the plurality of longitudinal convex strips 114a into the front and the back in the vehicle front-back direction Y. The transverse convex strip 114c extends along the vehicle width direction X. Furthermore, the patch component 150 includes a first joining portion 152. The first joining portion 152 is joined to the plurality of longitudinal convex strips 114a at the front and back end portions of the patch component 150 in the vehicle front-back direction Y. As a result, the force applied to the patch component 150 can be distributed to various places in the floor bottom panel 110 through the plurality of longitudinal convex strips 114a to suppress deformation of the floor bottom panel 110. For example, a plurality of first joining portions 152 are disposed corresponding to the longitudinal convex strips 114a for one-to-one joining. However, in other embodiments not shown, the first joining portion 152 can also be in the form of one strip and be joined to the plurality of longitudinal convex strips 114a at the same time, and the disclosure is not limited thereto. The joining method of the first joining portion 152 is, for example, welding, but may also be other appropriate joining methods.

In addition, the patch component 150 further includes a second joining portion 154. In a viewing angle in the vehicle up-down direction Z (that is, from the viewing angle of FIG. 2), the second joining portion 154 is formed to overlap the spacing portion 114b, and the second joining portion 154 is joined to the spacing portion 114b. Furthermore, in the viewing angle in the vehicle front-back direction Y, the first joining portions 152 and the second joining portions 154 are formed into a staggered arrangement in the vehicle width direction X. That is to say, the second joining portion 154 is not disposed in the extending direction of the longitudinal convex strip 114a. Therefore, the force applied to the patch component 150 can be dispersedly transmitted to the floor bottom panel 110 through the first joining portion 152 and the second joining portion 154 to suppress deformation of the floor bottom panel 110. The joining method of the second joining portion 154 is, for example, welding, but may also be other appropriate joining methods.

Furthermore, the transverse convex strip 114c is disposed at a position further forward than the second joining portion 154 in the vehicle front-back direction Y. In a viewing angle in the vehicle up-down direction Z (that is, from the viewing angle of FIG. 2), the transverse convex strip 114c is formed to overlap the plurality of longitudinal convex strips 114a. Specifically, the transverse convex strip 114c overlap the ends of the plurality of longitudinal convex strips 114a close to the spacing portion 114b. With such a configuration, the load transmitted by falling objects or the support legs can be efficiently distributed in the vehicle width direction X through the transverse convex strip 114c. In addition, in the event of a side impact, the transverse convex strip 114c can also play a role in enhancing the rigidity in the vehicle width direction X.

Furthermore, in the embodiment, the patch component 150 is formed into a rectangular shape such that a length in the vehicle width direction X is greater than a length in the vehicle front-back direction Y, but the disclosure is not limited thereto, so long as it is formed into a shape that can enhance the rigidity of the bottom panel portion 114. A distance D2 in which the patch component 150 extends toward the outer side from the central side (i.e., the center line C) of the bottom panel portion 114 in the vehicle width direction X is greater than a distance D1 in which the patch component 150 extends toward the inner side from the central side (i.e., the center line C) of the bottom panel portion 114 in the vehicle width direction X. In addition, the patch component 150 is formed away from the floor tunnel portion 112 and the side beam 120 in the vehicle width direction X. In detail, a gap G2 between the patch component 150 and the side beam 120 is smaller than a gap G1 between the patch component 150 and the floor tunnel portion 112. That is, the entire patch component 150 is disposed to be offset closer to the outer side in the vehicle width direction X. In this way, the load transmitted by falling objects or the support legs can be distributed to the side beams 120 with higher rigidity to suppress the deformation of the bottom panel portion 114. Moreover, the offset disposition makes the placement of the passengers' feet more comfortable when riding.

To sum up, in the vehicle bottom structure of the disclosure, the patch component is disposed on the bottom panel portion of the floor bottom panel, and the patch component is disposed between the first cross member and the second cross member, that is, roughly corresponding to the position between the front seats and the rear seats in the vehicle body. In this way, the load transmitted by falling objects or the support legs of the child chair can be borne by the patch component, and the force can be further distributed to various places in the floor bottom panel to suppress the deformation of the bottom panel portion. In addition, the patch component can also increase the rigidity of areas where cross members are not disposed to suppress deformation caused by side impacts. In addition, the bottom panel portion also includes the plurality of longitudinal convex strips, the spacing portion, and the transverse convex strip. The patch component includes the first joining portion and the second joining portion. The first joining portion is joined to the plurality of longitudinal convex strips at the front and back end portions of the patch component. The second joining portion is joined to the spacing portion of the bottom panel portion. The transverse convex strip is disposed in front of the spacing portion. As a result, the force applied to the patch component can be distributed to various places in the floor bottom panel through the plurality of longitudinal convex strips, the first joining portions, the second joining portions, and the transverse convex strip, thereby suppressing deformation of the floor bottom panel. Accordingly, the vehicle bottom structure of the disclosure can enhance the rigidity of the floor bottom panel between the front seats and the rear seats.

Finally, it should be noted that the above embodiments are merely used to illustrate the technical solution of the disclosure, but not to limit the disclosure. Although the disclosure has been described in detail with reference to the embodiments, it should be understood that persons of ordinary skill in the art can still modify the technical solutions recorded in the embodiments or make equivalent substitutions for some or all of the technical features. However, the modifications or substitutions do not cause the essence of the corresponding technical solution to depart from the scope of the technical solution of the embodiments of the disclosure.

What is claimed is:

1. A vehicle bottom structure, comprising:
a floor bottom panel, comprising a floor tunnel portion and a bottom panel portion;
side beams, disposed on an outer side of the floor bottom panel in a vehicle width direction, and extending along a vehicle front-back direction;
a first cross member and a second cross member, respectively disposed on a central side and a back end side of the floor tunnel portion in the vehicle front-back direction, and extending along the vehicle width direction; and
a patch component, disposed between the first cross member and the second cross member, wherein
the floor tunnel portion is disposed at a central side between the side beams in the vehicle width direction and extends along the vehicle front-back direction, and the bottom panel portion is disposed between the side beams and the floor tunnel portion,
part of the patch component overlaps a central side of the bottom panel portion in the vehicle width direction.

2. The vehicle bottom structure according to claim 1, wherein
the bottom panel portion comprises a plurality of longitudinal convex strips, and the plurality of longitudinal convex strips extend along the vehicle front-back direction and are disposed in parallel in the vehicle width direction,
the patch component comprises a first joining portion, and the first joining portion is joined to the plurality of longitudinal convex strips.

3. The vehicle bottom structure according to claim 2, wherein
the bottom panel portion also comprises a spacing portion, and the spacing portion separates the plurality of longitudinal convex strips into a front and a back in the vehicle front-back direction,
the patch component further comprises a second joining portion, in a viewing angle in a vehicle up-down direction, the second joining portion is formed to overlap the spacing portion, and the second joining portion is joined to the spacing portion,
in a viewing angle in the vehicle front-back direction, the first joining portions and the second joining portions are formed into a staggered arrangement in the vehicle width direction.

4. The vehicle bottom structure according to claim 3, wherein
the patch component also comprises a transverse convex strip extending along the vehicle width direction,
the transverse convex strip is disposed at a position further forward than the second joining portion in the vehicle front-back direction.

5. The vehicle bottom structure according to claim 4, wherein
in the viewing angle in the vehicle up-down direction, the transverse convex strip is formed to overlap the plurality of longitudinal convex strips.

6. The vehicle bottom structure according to claim 1, wherein
the patch component is formed such that a length in the vehicle width direction is greater than a length in the vehicle front-back direction, and
a distance in which the patch component extends from the central side of the bottom panel portion in the vehicle width direction toward an outer side is greater than a distance in which the patch component extends from the central side of the bottom panel portion in the vehicle width direction toward an inner side.

7. The vehicle bottom structure according to claim 1, wherein
the patch component is formed such that a length in the vehicle width direction is greater than a length in the vehicle front-back direction, and the patch component is formed away from the floor tunnel portion and the side beams in the vehicle width direction, wherein
a gap between the patch component and the side beams is smaller than a gap between the patch component and the floor tunnel portion.

8. The vehicle bottom structure according to claim 1, wherein
the first cross member is a front cross member connecting the floor tunnel portion and the side beams,
the second cross member is a back cross member connecting the side beams at a back end portion of the floor tunnel portion in the vehicle front-back direction.
